(19) United States
(12) Patent Application Publication
(10) Pub. No.: US 2023/0231867 A1
(43) Pub. Date: Jul. 20, 2023

(54) SYSTEM AND METHOD FOR ASSESSING A CYBER-RISK AND LOSS IN A CLOUD INFRASTRUCTURE

(71) Applicant: Tala Secure Inc., Mountain View, CA (US)

(72) Inventors: Raman Rampura Venkatachar, Bangalore (IN); Rajesh Kanungo, Mountain View, CA (US); Harold Lea, Alamo, CA (US); Benjamin R. Loomis, Sunnyvale, CA (US)

(21) Appl. No.: 18/098,609

(22) Filed: Jan. 18, 2023

Related U.S. Application Data
(60) Provisional application No. 63/361,776, filed on Jan. 18, 2022.

(51) Int. Cl. H04L 9/40; G06Q 10/0635

(52) U.S. Cl. CPC H04L 63/1433; G06Q 10/0635

(57) ABSTRACT

The embodiment herein provides a system and a method for assessing a cyber-risk and loss in a cloud infrastructure includes (a) deriving at least one of asset, topology, network or authentication vulnerabilities of a cloud infrastructure, (b) generating a technology risk machine learning model and a technology risk index, (c) generating a compliance risk machine learning model and a compliance risk, (d) generating a ransomware machine learning model and a business risk by processing (i) the compliance risk machine learning model and the compliance risk, (ii) a business input comprising asset information, cash flow, a value of the asset, (e) determining an asset's ransomware risk and loss based on the business risk and (f) automatically enabling one or more actions to mitigate the asset's ransomware risk and loss by fix misconfigurations or upgrading software using an API of cloud infrastructure.

### BACKGROUND

### Technical Field

The embodiments herein generally relate to a cloud infrastructure security, and more particularly, to a system and a method for assessing a cyber-risk and loss in a cloud infrastructure using one or more machine learning models.

### Description of the Related Art

In today's digital world, cybersecurity in cloud infrastructure is a critical concern for companies of all sizes and industries. With the increasing use of technology in every aspect of business, companies are at risk of cyberattacks that can lead to data breaches, loss of revenue, and reputational damage. One of the key challenges in protecting against such attacks is the need for skilled engineers who can identify and fix security vulnerabilities promptly.

Finding skilled engineers who can fix security vulnerabilities promptly before hackers can exploit them is a challenging task for companies. The cybersecurity field is constantly evolving, and it requires a high level of expertise and knowledge to be able to identify and fix vulnerabilities effectively. The shortage of skilled cybersecurity professionals is a well-documented problem, which makes it difficult for companies to find and retain the right talent. However, many security fixes are repetitive, which means that they require a high degree of attention to detail and the ability to work on the same type of task for extended periods. This leads to a high level of burnout among security engineers, which further exacerbate the shortage of skilled professionals in the field. Further, security fixes often require special syntax and technical skills, which make it difficult for engineers who are not familiar with the specific technology or tool to perform the fix. This leads to errors and mistakes that compromise the security of the system. Further, security issues occurs due to a variety of reasons, including errors committed by development engineers, deployment engineers, software bugs, protocol bugs, or cloud service provider's bugs. This makes it even more challenging to identify and fix vulnerabilities as they come from different sources and can be hard to identify.

Further, prioritizing vulnerabilities in cloud infrastructure based on their threats to the system is an important aspect of cybersecurity. With the increasing number of vulnerabilities in a system, it can be difficult to determine which ones to fix first. This is where threat prioritization comes in. By identifying the vulnerabilities that pose the greatest risk to the system, security engineers can focus their efforts on fixing the most critical issues first. For example, hackers may use vulnerabilities to launch a denial-of-service attack, which makes a system unavailable to users, resulting in loss of revenue and damage to the company's reputation. Similarly, hackers may use vulnerabilities to steal sensitive information or to expose it to unauthorized parties, which can lead to data breaches and compliance violations. Hackers may also use vulnerabilities to destroy information or steal computing resources. Threat prioritization allows security engineers to focus on the vulnerabilities that pose the greatest risk to the system, rather than wasting time and resources on fixing low-risk vulnerabilities. This enables them to be more effective in protecting the system from cyberattacks. Prioritizing vulnerabilities based on risk to the system means that security engineers must consider not only the standalone security risk of a vulnerability, as measured by tools such as the Common Vulnerability Scoring System (CVSS) Calculator, but also the potential loss to the company if the vulnerability were to be exploited. This requires a more holistic approach to vulnerability management that takes into account the overall risk to the organization, rather than simply focusing on individual vulnerabilities and their associated CVSS scores. In practice, this might mean that security engineers prioritize vulnerabilities that could have a significant impact on the company's operations or reputation, even if they have a lower CVSS score, while lower-risk vulnerabilities that are less likely to cause significant harm may be given a lower priority. Further, vulnerabilities that are well-protected by firewalls, network access policies, and other security controls may be considered lower risk and therefore receive lower priority than vulnerabilities that are more exposed to potential attacks.

Further, determining the financial risk of ransomware to the system is an important aspect of cybersecurity. Ransomware is a type of malware that encrypts a user's files and demands payment in exchange for the decryption key. This type of attack can cause significant financial damage to a company, and it is important for companies to understand the potential financial risks associated with a ransomware attack. Traditional models for determining the financial risk of ransomware are not able to determine these risks in a timely manner, as they do not have direct access to the cloud infrastructure APIs. This is because traditional models rely on historical data and manual input, which can make it difficult to identify and respond to real-time threats. Further, with the shift to cloud infrastructure and the increasing use of third-party SaaS applications, the traditional perimeter security model is no longer effective in protecting against cyberattacks. This makes it more challenging for companies to identify and mitigate the financial risks associated with ransomware attacks.

To address this issue, companies need to adopt a proactive approach to cybersecurity by implementing automation tools that can provide real-time visibility into the cloud infrastructure, and by adopting a Zero-Trust security model. This will enable companies to identify and respond to threats in real-time, and to minimize the financial risks associated with ransomware attacks. The Zero-Trust security model is a security approach that assumes that all network entities, both internal and external, are potentially untrusted and must be verified and authenticated before being granted access to resources. This differs from the traditional security model, which assumes that once a device or user is inside the network perimeter, they are trusted, and access to resources is granted automatically. The Zero-Trust model is necessary due to the changing nature of IT infrastructure. With the rise of cloud computing, mobile devices, and remote work, it's becoming increasingly difficult to maintain a strict perimeter between an organization's internal network and the external world. This means that traditional security models, which rely on a perimeter to protect resources, are no longer effective.

In Zero-Trust model, the security is implemented by verifying and authenticating each request for access to resources, regardless of the source or location of the request. This means that every device, user, and network interaction must be validated before access is granted. This approach is sometimes called “never trust, always verify.”. In Zero-Trust security model, a variety of technologies and protocols, such as multi-factor authentication, network segmentation, and micro-segmentation, are used to validate and authenticate requests for access to resources. Further, Zero-Trust security solutions are built around a set of security principles, such as least privilege, continuous monitoring, and automated threat response, which are designed to ensure that only authorized users and devices have access to sensitive resources and data.

To address these challenges, companies need to adopt a multi-faceted approach that includes training and development for security engineers, implementation of automation tools, and adoption of a zero-trust security model. Further, companies must regularly review and update their security protocols to ensure that they are in line with the latest industry standards. By taking a proactive approach to cybersecurity, companies can protect their assets, reputation and mitigate the potential financial risks associated with cyber-attacks. Accordingly, there remains a need for a system and method for fixing cyber-security issues and corresponding loss.

### SUMMARY

In view of the foregoing, an embodiment herein provides a security system for assessing a cyber-risk and loss in a cloud infrastructure. The security system includes a memory and a processor. The processor that is configured to (a) derive, using at least one specific connector, at least one of asset, topology, network or authentication vulnerabilities of a cloud infrastructure, (b), generate a technology risk machine learning model and a technology risk index by normalizing, using a machine learning model, the at least one of asset, topology, network or authentication with vulnerabilities of the cloud infrastructure, (c) generate a compliance risk machine learning model and a compliance risk by processing the technology risk machine learning model including at least one of the categorized data, network, computation or authentication of the cloud infrastructure or the technology risk index, (d) generate a ransomware machine learning model and a business risk by processing (i) the compliance risk machine learning model and the compliance risk, (ii) a business input including asset information, cash flow, a value of the asset, (e) determine, using at least one of the technology risk machine learning model, the compliance risk machine learning model or the ransomware machine learning model, an asset's ransomware risk and loss based on the business risk and (f) automatically enabling one or more actions to mitigate the asset's ransomware risk and loss by fix misconfigurations or upgrading software using an API of cloud infrastructure. The technology risk machine learning model includes technology risk information that is categorized based on a type of at least one of data, a network, computation or authentication of the cloud infrastructure,

In some embodiments, the processor is configured to generate the technical risk machine learning model by training a machine learning model using at least one of data associated with (a) security standards, (b) security vulnerabilities, (c) a location associated with the cloud infrastructure, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (l) static and dynamic code analysis results.

In some embodiments, the processor is configured to generate the compliance risk machine learning model by training the machine learning model with a technical risk index that is generated by the technical risk machine learning model.

In some embodiments, the processor is configured to generate the ransomware risk machine learning model by training the machine learning model with the compliance risk index that is generated by the compliance risk machine learning model.

In some embodiments, the processor is configured to (a) derive at least one of data associated with business to determine business risks associated with assets or cash-flow, (b) determine, using at least one of the technology risk machine learning model, the compliance risk machine learning model or the ransomware machine learning model, the business risk associated with the assets or the cash-flow based on the derived data and inputs associated with the business and industries, (c) determine, at least one of the technology risk machine learning model, the compliance risk machine learning model or the ransomware machine learning model, ranks for the technical risk, the compliance risk, the ransomware risk or the business risk and (d) enable at least one action to resolve at least issues assessed using the technical risk, the compliance risk, the ransomware risk or the business risk based on the determined ranks.

In some embodiments, the processor is configured to (a) determine ranks for at least one of the technical risks, the compliance risk, the ransomware risk or the business and (b) prioritize at least one action to normalize the vulnerabilities associated with the technical risk, the compliance risk, the ransomware risk or the business risk based on the determined ranks.

In some embodiments, the security system performs at least one of any misconfigurations, upgrade software, automatically generating notifications to administrators or provide at least one option to normalize the vulnerabilities associated with the technical risk, the compliance risk, the ransomware risk or the business risk.

In some embodiments, the processor is configured to determine the security vulnerabilities by deriving data associated with at least one of (i) Common Vulnerability Scoring System (CVSS) score, (ii) security standards, (iii) location, (iv) storage or compute resource, (v) misconfigured security parameters, network security components, (vi) identity management, (vii) absence of disaster recovery, back-up, incidence response systems, (viii) vulnerability scan results or (ix) static or dynamic code analysis results.

In another aspect, an embodiment herein provides a method for assessing a cyber-risk and loss in a cloud infrastructure includes (a) deriving, using at least one specific connector, at least one of asset, topology, network or authentication vulnerabilities of a cloud infrastructure, (b) generating a technology risk machine learning model and a technology risk index by normalizing, using a machine learning model, the at least one of asset, topology, network or authentication with vulnerabilities of the cloud infrastructure, (c) generating a compliance risk machine learning model and a compliance risk by processing the technology risk machine learning model including at least one of the categorized data, network, computation or authentication of the system and the technology risk index, (d) generating a ransomware machine learning model and a business risk by processing (i) the compliance risk machine learning model and the compliance risk, (ii) a business input including asset information, cash flow, a value of the asset, (e) determining, using at least one of the technology risk machine learning model, the compliance risk machine learning model or the ransomware machine learning model, an asset's ransomware risk and loss based on the business risk and (f) automatically enabling one or more actions to mitigate the asset's ransomware risk and loss by fix misconfigurations or upgrading software using an API of cloud infrastructure. The machine learning model includes technology risk information that is categorized based on a type of at least one of data, a network, computation or authentication of a system.

In some embodiments, method includes generating the technical risk machine learning model by training a machine learning model using at least one of data associated with (a) security standards, (b) security vulnerabilities, (c) a location associated with the cloud infrastructure, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (l) static and dynamic code analysis results.

In some embodiments, method includes generating the compliance risk machine learning model by training the machine learning model with a technical risk index that is generated by the technical risk machine learning model.

In some embodiments, method includes generating the ransomware risk machine learning model by training the machine learning model with the compliance risk index that is generated by the compliance risk machine learning model.

In some embodiments, method includes (a) deriving at least one of data associated with business to determine business risks associated with assets or cash-flow, (b) determining, using at least one of the technology risk machine learning model, the compliance risk machine learning model or the ransomware machine learning model, the business risk associated with the assets or the cash-flow based on the derived data and inputs associated with the business and industries, (c) determining, at least one of the technology risk machine learning model, the compliance risk machine learning model or the ransomware machine learning model, ranks for the technical risk, the compliance risk, the ransomware risk or the business risk, (d) enabling at least one action to resolve at least issues assessed using the technical risk, the compliance risk, the ransomware risk or the business risk based on the determined ranks.

In some embodiments, method includes (a) determining ranks for at least one of the technical risks, the compliance risk, the ransomware risk or the business and (b) prioritizing at least one actions to normalize the vulnerabilities associated with the technical risk, the compliance risk, the ransomware risk or the business risk based on the determined ranks.

In some embodiments, method includes performing at least one of any misconfigurations, upgrade software, automatically generating notifications to administrators or provide at least one option to normalize the vulnerabilities associated with the technical risk, the compliance risk, the ransomware risk or the business risk.

In some embodiments, method includes determining the security vulnerabilities by deriving data associated with at least one of (i) Common Vulnerability Scoring System (CVSS) score, (ii) security standards, (iii) location, (iv) storage or compute resource, (v) misconfigured security parameters, network security components, (vi) identity management, (vii) absence of disaster recovery, back-up, incidence response systems, (viii) vulnerability scan results or (ix) static or dynamic code analysis results.

The security system replaces skilled engineers to fix security vulnerabilities. The security system adapts with different industries. The security system automatically prioritizes the cyber-risk and fix accordingly. The loss is assessed based on the prioritized the cyber-risk. The security system adapts with a Zero-trust security model.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a system view of a security system for assessing a cyber-risk and loss in one or more cloud infrastructures according to some embodiments herein;

FIG. 2 illustrates an exemplary exploded view of the security system of FIG. 1 for assessing the cyber-risk and loss in the one or more cloud infrastructures according to some embodiments herein;

FIG. 3 illustrates a process flow diagram for assessing the cyber-risk and loss in the one or more cloud infrastructures of FIG. 1 according to some embodiments herein;

FIG. 4 illustrates an exemplary architecture diagram of the security system of FIG. 1 according to some embodiments herein;

FIG. 5 is a flow diagram illustrating a method for assessing a cyber-risk and loss in a cloud infrastructure using the security system of FIG. 1 according to some embodiments herein;

FIG. 6 illustrates an exploded view of a security system according to the embodiments herein; and

FIG. 7 is a schematic diagram of a computer architecture used in accordance with the embodiment herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

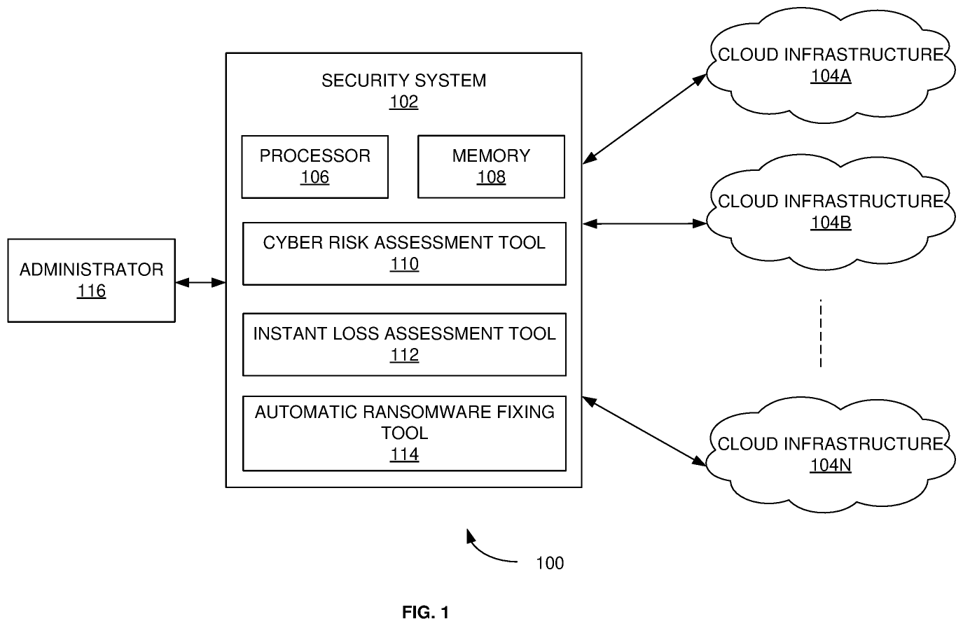

As mentioned, there remains a need for a system and method for fixing cyber-security issues and corresponding loss. Referring now to the drawings, and more particularly to FIGS. 1 through 7, where similar reference characters denote corresponding features consistently throughout the figures, there are shown preferred embodiments.

FIG. 1 illustrates a system view 100 of a security system 102 for assessing a cyber-risk and loss in one or more cloud infrastructures 104A-N according to some embodiments herein. The system view 100 includes the security system 102, the one or more cloud infrastructures 104A-N and an administrator 116. The security system 102 includes a processor 106, a memory 108, a cyber risk assessment tool 110, an instant loss assessment tool 112, an automatic ransomware fixing tool 114. The security system 102 is connected with the one or more cloud infrastructure 104A-N using one or more specific connectors. The security system 102 derives at least one of asset, topology, network or authentication vulnerabilities of the one or more cloud infrastructure 104A-N using the one or more specific connectors. In some embodiments, the security system 102 derives at least one of (a) security standards, (b) security vulnerabilities and associated score, (c) a location inside the one or more cloud infrastructures 104A-N, (d) other vulnerabilities parts of the one or more cloud infrastructures 104A-N, (e) misconfigurations of security parameters, identities management vulnerabilities, (f) absence of disaster recovery, backup, and incidence response systems, (g) misconfigured or missing network components, (h) vulnerability scan results or (i) results associated with static and dynamic code analysis.

In some embodiments, the security system 102 derives at least one of business inputs or industrial models to define levels of risks. In some embodiments, the security system 102 derives at least 42 categories of data to assess the cyber-risk and loss. The security system 102 may derive at least one of an industry profile, an industry risk, a business size, a headcount, a service type, a critical infra, an asset, a cash flow, business unit accounts, a loss resilience, an insurance, 3P supply, common controls, NIST-CSF, HIPAA, SoC2, PCI, NVD, Firewall, AVS, IAM roles, DLP, isolation, Key management, VPC, cloud trail, backup, IR, BC, DR, Patch management, RTO RPO, CloudWatch, RDS, K8S, EFS, S3, EC2, Redshift, Pentest, Web Security, API security, DoS resilience, Attack Surface, and App security.

The security system 102 assess the cyber-risk and loss for the one or more cloud infrastructures 104A-N using the cyber-risk assessment tool 110. The cyber risk assessment tool 110 generates at least one of a technology risk, a compliance risk, or a ransomware risk using the derived information associated with the one or more cloud infrastructures 104A-N. The security system 102 assess a business risk using the instant loss assessment tool 112 using the at least one of the compliance risk, the business inputs or industrial models. The security system 102 determines the cyber-risk and loss for the one or more cloud infrastructures 104A-N based on the business risk.

The security system 102 automatically fixing the determined cyber-risk and loss using the automatic ransomware fixing tool 114. The automatic ransomware fixing tool 114 fixes cyber-risk and loss by fixing the misconfigurations or upgrading software using an API of the one or more cloud infrastructures 104A-N. In some embodiments, the automatic ransomware fixing tool 114 enables one or more actions to fix the cyber-risk and loss without inputs of the administrator 116. In some embodiments, the security system 102 includes one or more machine learning models to determine at least one of the technology risk, the compliance risk, the business risk or the ransomware risk. In some embodiments, the security system 102 includes one or more machine learning models to mitigate the ransomware risk and loss by fix misconfigurations or upgrading software using an API of the one or more cloud infrastructures 104A-N. In some embodiments, the security system 102 assessment is non-perimeter based.

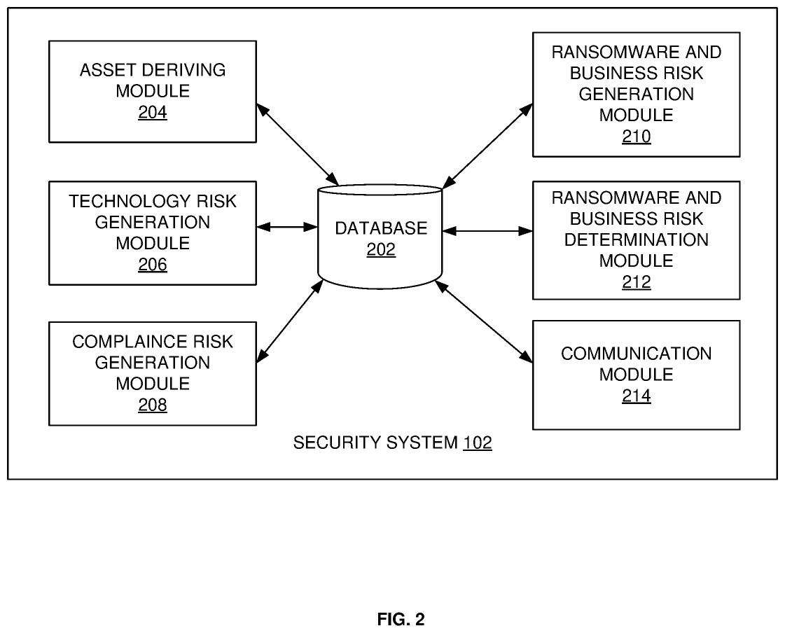

FIG. 2 illustrates an exemplary exploded view of the security system 102 of FIG. 1 for assessing the cyber-risk and loss in the one or more cloud infrastructures 104A-N according to some embodiments herein. The security system 102 includes a database 202, an asset deriving tool 204, a technology risk generation module 206, a compliance risk generation module 208, a ransomware and business risk generation module 210, a ransomware and business risk determination module 212, a communication module 214. The asset deriving tool 204 derives at least one of asset, topology, network or authentication vulnerabilities of the one or more cloud infrastructures 104A-N using the one or more specific connectors. In some embodiments, the asset deriving tool 204 derives at least one of (a) security standards, (b) security vulnerabilities and associated score, (c) the location inside the one or more cloud infrastructures 104A-N, (d) other vulnerabilities parts of the one or more cloud infrastructures 104A-N, (e) misconfigurations of security parameters, identities management vulnerabilities, (f) absence of disaster recovery, backup, and incidence response systems, (g) misconfigured or missing network components, (h) vulnerability scan results or (i) results associated with static and dynamic code analysis. In some embodiments, the asset deriving tool 204 derives at least one business inputs or industry models to determine levels of the cyber-risk and loss. In some embodiments, the asset deriving tool 204 derives at least one of data associated with business to determine business risks associated with assets or cash-flow. The compliance risk generation module 208 generates a compliance risk machine learning model and a compliance risk by processing the technology risk machine learning model that includes at least one of the categorized data, network, computation or authentication of the one or more cloud infrastructures 104A-N or the technology risk index. In some embodiments, the compliance risk machine learning model is generated by training the machine learning model with a technical risk index that is generated by the technical risk machine learning model.

The technology risk generation module 206 generates at least one of a technology risk machine learning model and a technology risk index by normalizing the at least one of asset, topology, network or authentication with vulnerabilities of the one or more cloud infrastructures 104A-N. In some embodiments, the technology risk generation module 206 is generated by training a machine learning model using at least one of data associated with (a) security standards, (b) security vulnerabilities, (c) a location associated with the one or more cloud infrastructures 104A-N, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (1) static and dynamic code analysis results. In some embodiments, the technology risk machine learning model includes technology risk information that is categorized based on a type of at least one of data, a network, computation or authentication of the one or more cloud infrastructures 104A-N.

The ransomware and business risk generation module 210 generates a ransomware machine learning model and a business risk by processing (i) the compliance risk machine learning model and the compliance risk, (ii) a business input including asset information, cash flow, a value of the asset, number of employees, or security practices in place. In some embodiments, the ransomware risk machine learning model is generated by training the machine learning model with a compliance risk index that is generated by the compliance risk machine learning model.

The ransomware and business risk determination module 212 determines an asset's ransomware risk and loss based on the business risk using at least one of the technology risk machine learning model, the compliance risk machine learning model or the ransomware machine learning model. In some embodiments, the ransomware and business risk determination module 212 ranks for the technical risk, the compliance risk, the ransomware risk or the business risk using at least one of the technology risk machine learning model, the compliance risk machine learning model or the ransomware machine learning model. The ransomware and business risk determination module 212 ranks for the technical risk, the compliance risk, the ransomware risk or the business risk. The ransomware and business risk determination module 212 automatically enables one or more actions to mitigate the asset's ransomware risk and loss by fix misconfigurations or upgrading software using an API of the one or more cloud infrastructures 104A-N. In some embodiments, the ransomware and business risk determination module 212 enable at least one action to resolve at least issues assessed using the technical risk, the compliance risk, the ransomware risk or the business risk based on the determined ranks.

In some embodiments, the ransomware and business risk determination module 212 prioritize at least one actions to normalize the vulnerabilities associated with the technical risk, the compliance risk, the ransomware risk or the business risk based on the determined ranks. In some embodiments, the technical risk and the compliance risk are ranked between 0 to 1. In some embodiments, the at least one actions includes fixing misconfigurations, upgrade software, automatically generating notifications to the administrator 116 or provide at least one option to normalize the vulnerabilities associated with the technical risk, the compliance risk, the ransomware risk or the business risk. In some embodiments, the security system 102 normalize the vulnerabilities associated with the technical risk, the compliance risk, the ransomware risk or the business risk using one or more API. The communication module 214 communicates at least one data between the security system 102 and the one or more cloud infrastructures 104A-N.

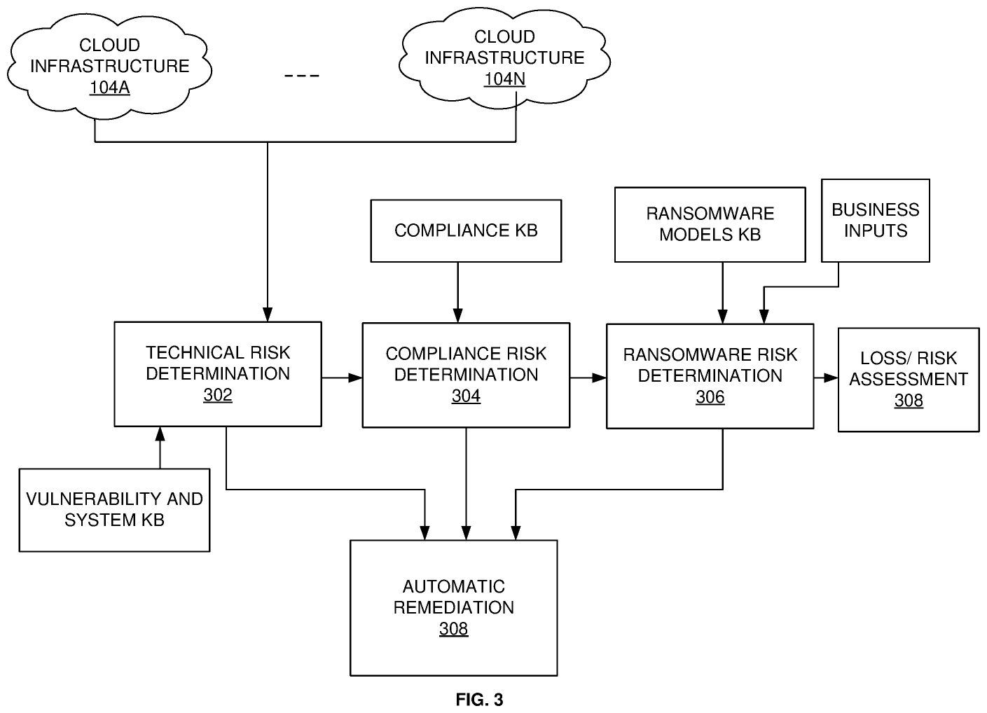

FIG. 3 illustrates a process diagram of assessing the cyber-risk and loss in the one or more cloud infrastructures 104A-N using the security system 102 of FIG. 1 according to some embodiments herein. At step 302, the technical risk is determined using the technology risk machine learning model. In some embodiments, the technical risk machine learning model is generated by training a machine learning model using at least one of data associated with (a) security standards, (b) security vulnerabilities, (c) a location associated with the one or more cloud infrastructures 104A-N, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (1) static and dynamic code analysis results. In some embodiments, the technical risk is determined using the data associated with of the one or more cloud infrastructures 104A-N that are derived using the one or more specific connectors. In some embodiments, the security system 102 determines the technology risk index using the data that are derived from the one or more cloud infrastructures 104A-N. In some embodiments, the technology risk machine learning model includes at least one of the categorized data, network, computation or authentication of the one or more cloud infrastructures 104A-N or the technology risk index. At a step 304, the compliance risk is generated using the compliance risk machine learning model. The compliance risk machine learning model is generated by training the machine learning model with a technical risk index that is generated by the technical risk machine learning model.

At a step 306, the business risk is generated by processing (i) the compliance risk machine learning model and the compliance risk, (ii) a business input including asset information, cash flow, a value of the asset using the ransomware machine learning model. In some embodiments, the ransomware machine learning model is generated by training the machine learning model with the compliance risk index that is generated by the compliance risk machine learning model. In some embodiments, the business risk associated with the assets or the cash-flow is determined based on the derived data and inputs associated with the business and industries. At a step 308, the cyber-risk and loss is assessed by determining an asset's ransomware risk and loss based on the business risk. In some embodiments, the security system 102 automatically enables one or more actions to mitigate the asset's ransomware risk and loss by fix misconfigurations or upgrading software using an API of one or more cloud infrastructures 104A-N. In some embodiments, the technical risk, the compliance risk, the ransomware risk or the business risk are ranked between 0 to 1 to enable at least one action to resolve at least issues assessed using the technical risk, the compliance risk, the ransomware risk or the business risk based on the determined ranks.

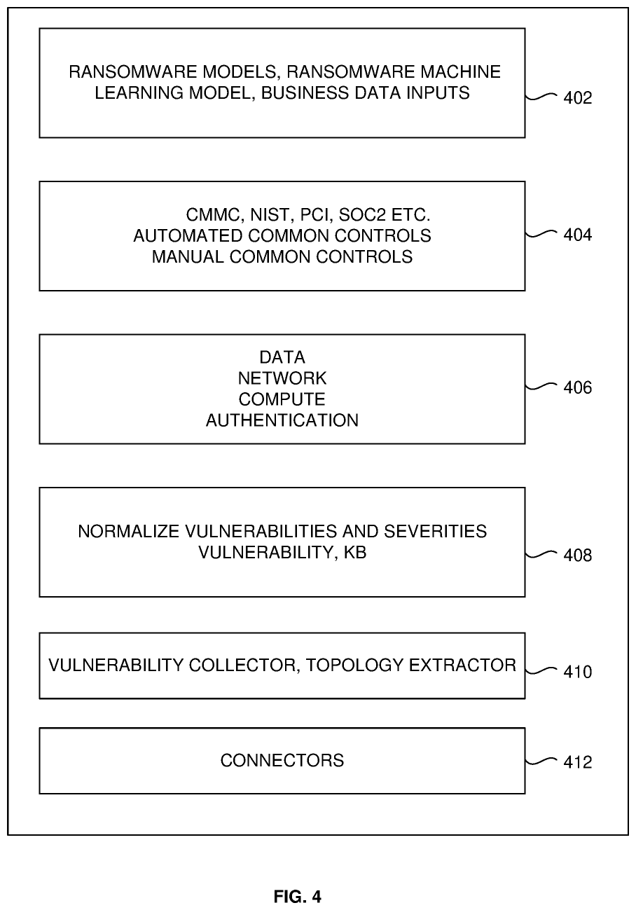

FIG. 4 illustrates an exemplary architecture diagram of the security system 102 of FIG. 1 according to some embodiments herein. The architecture of the security system 102 includes an analysis layer 402, a compliance layer 404, a system vulnerability layer 406, an individual issue layer 408, an information layer 410 and a connector layer 412. The analysis layer 402 includes at least one of ransomware models, ransomware machine learning model, business data inputs. The compliance layer 404 includes CMMC, NIST, PCI, SOC2, automated common controls, manual common controls. The system vulnerability layer 406 includes data, network, compute, authentication. The individual issue layer 408 includes normalize vulnerabilities and severities and vulnerability, KB. The information layer 410 includes vulnerability collector, topology extractor. The connector layer 412 includes one or more cloud specific connectors to derive data from one or more cloud infrastructures 104A-N. In some embodiments, the one or more cloud infrastructures 104A-N (For example: Amazon Web Services (AWS)) includes one or more API to fix misconfigurations or upgrading software for mitigate the ransomware risk and loss.

The one or more cloud infrastructures 104A-N includes one or more API to design and deploy entire cloud infrastructure that includes at least one of servers, databases, firewalls, routers or storage systems. In some embodiments, the one or more cloud infrastructures 104A-N includes one or more API to configure or reconfigure the resources.

In some embodiments, the one or more cloud infrastructures 104A-N (For example: Amazon Web Services (AWS)) includes one or more API to fix misconfigurations or upgrading software for mitigate the ransomware risk and loss. The AWS provides API to enable encrypted storage of data in Amazon Simple Storage Service (S3). The AWS provides API to limit access to the S3 data using a Transport Layer Security (TLS). In some embodiments, the AWS turning on Database encryption by providing API to enable encrypted storage of data in Amazon Simple Storage Service (S3). An appropriate encryption algorithm is chosen and set by invoking AWS S3 API setApplyServerSideEncryptionByDefault( . . . ).

In some embodiments, the security system 102 fixes, when an S3 bucket is provisioned for reading and/or writing to it publicly by pushing an appropriate policy using AWS S3 API SetBucketPolicy( . . . ). In some embodiments, a similar approach is performed when security system 102 detects that access to the S3 bucket is made without usage of the Transport Layer Security (TLS).

In some embodiments, when critical data is stored in S3 and replication has been configured, the security system 102 sets up replication by creating a bucket in another region and creating replication rules and applying it via AWS API setBucketReplicationConfiguration( . . . ).

When the security system 102 detects that incoming traffic is allowed from anonymous IPs on critical ports, the security system 102 examines all the ports and the protocols allowing incoming traffic not just for the instance but on the entire security group and revokes incoming traffic permissions by invoking AWS API revokeSecurityGroupIngress( . . . ). In some embodiments, when security system 102 detects unused Elastic IPs hanging around the security system 102 releases the IPs by invoking release address( . . . ). In some embodiments, Elastic Components (EC) instances are publicly accessible to the interne, the security system 102 disassociates the public IP attached to Elastic component (EC) instance by invoking AWS API disassociateAddress( . . . ). In some embodiments, when the security system 102 detects Elastic component (EC) instances that are running obsolete versions of software or need patches to be applied it registers it with AWS Systems Manager (SSM) by configuring the inventory of softwares and associating the instances using AWS SSM createAssociation( . . . ).

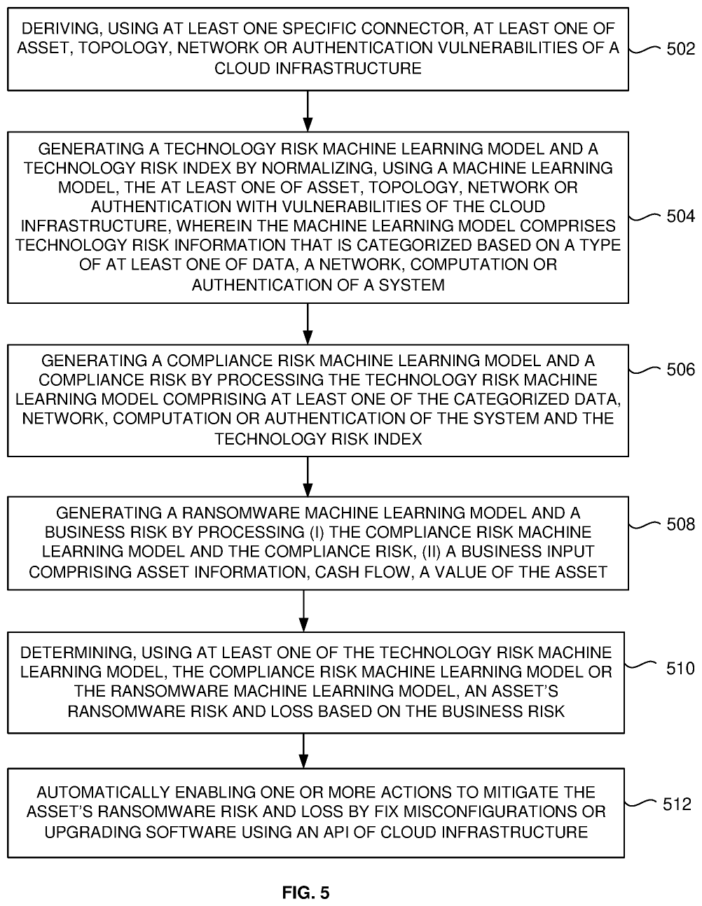

FIG. 5 is a flow diagram illustrating a method for assessing a cyber-risk and loss in a cloud infrastructure using the security system 102 of FIG. 1 according to some embodiments herein. At a step 502, network or authentication vulnerabilities of a cloud infrastructure are derived using at least one specific connector, at least one of asset, topology. At a step 504, the technology risk machine learning model and the technology risk index are generated by normalizing, using a machine learning model, the at least one of asset, topology, network or authentication with vulnerabilities of the cloud infrastructure. At a step 506, a compliance risk machine learning model and a compliance risk are generated by processing the technology risk machine learning model that includes at least one of the categorized data, network, computation or authentication of the system and the technology risk index. At a step 508, a ransomware machine learning model and a business risk is generated by processing (i) the compliance risk machine learning model and the compliance risk, (ii) a business input including asset information, cash flow, a value of the asset. At a step 510, an asset's ransomware risk and loss based on the business risk are determined using at least one of the technology risk machine learning model, the compliance risk machine learning model or the ransomware machine learning model. At a step 512, one or more actions are automatically enabled to mitigate the asset's ransomware risk and loss by fix misconfigurations or upgrading software using an API of cloud infrastructure.

In some embodiments, the machine learning model includes technology risk information that is categorized based on a type of at least one of data, a network, computation or authentication of the cloud infrastructure.

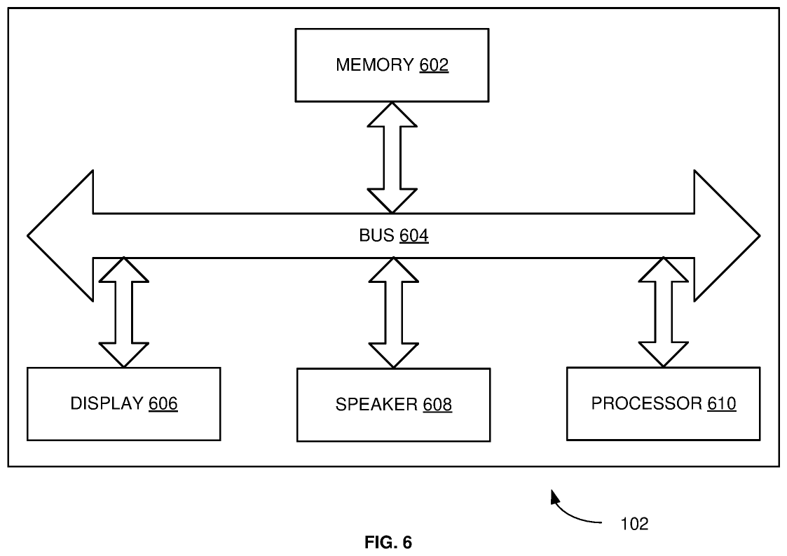

FIG. 6 illustrates an exploded view of the security system 102 having a memory 602 having a set of computer instructions, a bus 604, a display 606, a speaker 608, and a processor 610 capable of processing a set of instructions to perform any one or more of the methodologies herein, according to an embodiment herein. The processor 610 may also enable digital content to be consumed in the form of a video for output via one or more displays 606 or audio for output via speaker and/or earphones 608. The processor 610 may also carry out the methods described herein and in accordance with the embodiments herein.

Digital content may also be stored in the memory 602 for future processing or consumption. The memory 602 may also store program specific information and/or derived data that includes at least one of (a) security standards, (b) security vulnerabilities and associated score, (c) location inside the cloud infrastructure 104, (d) other vulnerabilities parts of the cloud infrastructure 104, (e) misconfigurations of security parameters, identities management vulnerabilities, (f) absence of disaster recovery, backup, and incidence response systems, (g) misconfigured or missing network components, (h) vulnerability scan results or (i) results associated with static and dynamic code analysis associated with the one or more cloud infrastructure 104A-N. A user of the personal communication device may view this stored information on display 606 and select an item for viewing, listening, or other uses via input, which may take the form of a keypad, scroll, or another input device (s) or combinations thereof. When digital content is selected, the processor 610 may pass information. The derived data may be passed among functions within the personal communication device using the bus 604.

The embodiments herein can take the form of, an entire hardware embodiment, an entire software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a or any instruction execution system. For the purposes of this description, a computer-usable or computer-readable medium can be any apparatus that can include, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet cards are just a few of the currently available types of network adapters.

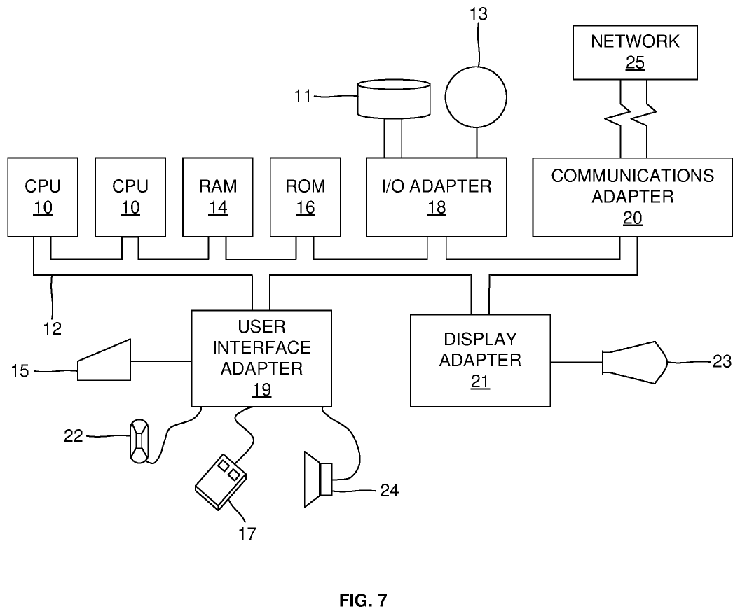

A representative hardware environment for practicing the embodiments herein is depicted in FIG. 7. This schematic drawing illustrates a hardware configuration of an information handling/computer system in accordance with the embodiments herein. The security system 102 includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to a bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A security system for assessing a cyber-risk and loss in a cloud infrastructure, comprising:
a memory;
a processor that is configured to:
derive, using at least one specific connector, at least one of asset, topology, network or authentication vulnerabilities of a cloud infrastructure;
generate a technology risk machine learning model and a technology risk index by normalizing, using a machine learning model, the at least one of asset, topology, network or authentication with vulnerabilities of the cloud infrastructure, wherein the technology risk machine learning model comprises technology risk information that is categorized based on a type of at least one of data, a network, computation or authentication of the cloud infrastructure;
generate a compliance risk machine learning model and a compliance risk by processing the technology risk machine learning model comprising at least one of the categorized data, network, computation or authentication of the cloud infrastructure or the technology risk index;
generate a ransomware machine learning model and a business risk by processing (i) the compliance risk machine learning model and the compliance risk, (ii) a business input comprising asset information, cash flow, a value of the asset;
determine, using at least one of the technology risk machine learning model, the compliance risk machine learning model or the ransomware machine learning model, an asset's ransomware risk and loss based on the business risk; and
automatically enabling one or more actions to mitigate the asset's ransomware risk and loss by fix misconfigurations or upgrading software using an API of cloud infrastructure.

2. The security system of claim 1, wherein the processor is configured to
generate the technical risk machine learning model by training a machine learning model using at least one of data associated with (a) security standards, (b) security vulnerabilities, (c) a location associated with the cloud infrastructure, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (l) static and dynamic code analysis results.

3. The security system of claim 1, wherein the processor is configured to generate the compliance risk machine learning model by training the machine learning model with a technical risk index that is generated by the technical risk machine learning model.

4. The security system of claim 1, wherein the processor is configured to generate the ransomware risk machine learning model by training the machine learning model with a compliance risk index that is generated by the compliance risk machine learning model.

5. The security system of claim 1, wherein the processor is configured to
derive at least one of data associated with business to determine business risks associated with assets or cash-flow;
determine, using at least one of the technology risk machine learning model, the compliance risk machine learning model or the ransomware machine learning model, the business risk associated with the assets or the cash-flow based on the derived data and inputs associated with the business and industries;
determine, at least one of the technology risk machine learning model, the compliance risk machine learning model or the ransomware machine learning model, ranks for the technical risk, the compliance risk, the ransomware risk or the business risk;
enable at least one action to resolve at least issues assessed using the technical risk, the compliance risk, the ransomware risk or the business risk based on the determined ranks.

6. The security system of claim 1, wherein the processor is configured to
determine ranks for at least one of the technical risks, the compliance risk, the ransomware risk or the business; and
prioritize at least one actions to normalize the vulnerabilities associated with the technical risk, the compliance risk, the ransomware risk or the business risk based on the determined ranks.

7. The security system of claim 1, wherein the security system performs at least one of any misconfigurations, upgrade software, automatically generating notifications to administrators or provide at least one option to normalize the vulnerabilities associated with the technical risk, the compliance risk, the ransomware risk or the business risk.

8. The security system of claim 1, wherein the processor is configured to determine the security vulnerabilities by deriving data associated with at least one of (i) Common Vulnerability Scoring System (CVSS) score, (ii) security standards, (iii) location, (iv) storage or compute resource, (v) misconfigured security parameters, network security components, (vi) identity management, (vii) absence of disaster recovery, back-up, incidence response systems, (viii) vulnerability scan results or (ix) static or dynamic code analysis results.

9. A method for assessing a cyber-risk and loss in a cloud infrastructure, comprising:
deriving, using at least one specific connector, at least one of asset, topology, network or authentication vulnerabilities of a cloud infrastructure;
generating a technology risk machine learning model and a technology risk index by normalizing, using a machine learning model, the at least one of asset, topology, network or authentication with vulnerabilities of the cloud infrastructure, wherein the machine learning model comprises technology risk information that is categorized based on a type of at least one of data, a network, computation or authentication of the cloud infrastructure;
generating a compliance risk machine learning model and a compliance risk by processing the technology risk machine learning model comprising at least one of the categorized data, network, computation or authentication of the system and the technology risk index;
generating a ransomware machine learning model and a business risk by processing (i) the compliance risk machine learning model and the compliance risk, (ii) a business input comprising asset information, cash flow, a value of the asset;
determining, using at least one of the technology risk machine learning model, the compliance risk machine learning model or the ransomware machine learning model, an asset's ransomware risk and loss based on the business risk; and
automatically enabling one or more actions to mitigate the asset's ransomware risk and loss by fix misconfigurations or upgrading software using an API of cloud infrastructure.

10. The method of claim 9, wherein the method comprises generating the technical risk machine learning model by training a machine learning model using at least one of data associated with (a) security standards, (b) security vulnerabilities, (c) a location associated with the cloud infrastructure, (d) cloud storages and resources, (e) misconfiguration of security parameters, (f) identity management vulnerabilities, (g) absence of disaster recovery, (h) absence of backup, (i) absence of incidence response, (j) misconfigured or missing network security components, (k) vulnerability scan results, or (l) static and dynamic code analysis results.

11. The method of claim 9, wherein the method comprises generating the compliance risk machine learning model by training the machine learning model with a technical risk index that is generated by the technical risk machine learning model.

12. The method of claim 9, wherein the method comprises generating the ransomware risk machine learning model by training the machine learning model with a compliance risk index that is generated by the compliance risk machine learning model.

13. The method of claim 9, wherein the method comprises
deriving at least one of data associated with business to determine business risks associated with assets or cash-flow;
determining, using at least one of the technology risk machine learning model, the compliance risk machine learning model or the ransomware machine learning model, the business risk associated with the assets or the cash-flow based on the derived data and inputs associated with the business and industries;
determining, at least one of the technology risk machine learning model, the compliance risk machine learning model or the ransomware machine learning model, ranks for the technical risk, the compliance risk, the ransomware risk or the business risk;
enabling at least one action to resolve at least issues assessed using the technical risk, the compliance risk, the ransomware risk or the business risk based on the determined ranks.

14. The method of claim 9, wherein the method comprises
determining ranks for at least one of the technical risks, the compliance risk, the ransomware risk or the business; and
prioritizing at least one actions to normalize the vulnerabilities associated with the technical risk, the compliance risk, the ransomware risk or the business risk based on the determined ranks.

15. The method of claim 9, wherein the method comprises performing at least one of any misconfigurations, upgrade software, automatically generating notifications to administrators or provide at least one option to normalize the vulnerabilities associated with the technical risk, the compliance risk, the ransomware risk or the business risk.

16. The method of claim 9, wherein the method comprises determining the security vulnerabilities by deriving data associated with at least one of (i) Common Vulnerability Scoring System (CVSS) score, (ii) security standards, (iii) location, (iv) storage or compute resource, (v) misconfigured security parameters, network security components, (vi) identity management, (vii) absence of disaster recovery, back-up, incidence response systems, (viii) vulnerability scan results or (ix) static or dynamic code analysis results.
